(19) United States
(12) Patent Application Publication
(10) Pub. No.: US 2007/0051488 A1
(43) Pub. Date: Mar. 8, 2007

(54) Heat exchanger for motor vehicle

(75) Inventor: Ryoichi Hori, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/505,986

(22) Filed: Aug. 18, 2006

(30) Foreign Application Priority Data
Sep. 2, 2005 (JP) 2005-255385

(51) Int. Cl. B60H 1/00; F28D 1/04; F28F 9/02

(52) U.S. Cl. 165/41; 165/151; 165/175

(57) ABSTRACT

A heat exchanger for a motor vehicle includes a pair of tanks apart from each other, and a core part including a plurality of tubes and a plurality of fins. Each of the fins is arranged between the adjacent tubes, and the tubes are fixed at both end portions thereof with the tanks so that circulating medium can be cooled by air flow running through the core part and flows through the tubes and tanks. Connecting portions of the tubes and the tanks are covered by a windbreak member so that the connecting portions are prevented from being hit by the air flow running through the core port.

### BACKGROUND OF THE INVENTION

1. Field of the Invention

The present invention relates to a heat exchanger having a pair of tanks connected by a plurality of tubes where each tube is arranged between adjacent fins in order to cool circulating medium flowing through the tubes and tanks by air flow.

2. Description of the Related Art

A conventional heat exchanger for a motor vehicle of this kind is disclosed in Japanese patents laying-open publication No. 2003-42685 and No. (Tokkaihei) 11-173784. These heat exchangers have a pair of tanks apart in a lateral direction of a vehicle body, and a core part located between the tanks and having a plurality of tubes and fins arranged alternatively with each other. The tubes are connected at their both end portions with the tanks so as to flow circulating medium, such as coolant, therethrough and cool it by air flow passing through the core part.

However, the conventional heat exchanger has the following disadvantages. In general, the heat exchanger is mounted on a front end portion of a vehicle body, where a bumper armature and a front grille are provided in front of the heat exchanger. Accordingly, air flow caused when vehicle running and/or generated by a fan non-uniformly hit the tubes and fins of the heat exchanger, because the air flow changes depending on a mounting positions of the bumper armature and openings of the front grille. This non-uniformly hit of the air flow causes temperature difference between the tubes hit by strong air flow and the tubes hit by weak air flow. In consequence, some tubes are damaged at their connecting portions fixed to the tanks due to thermal stress.

It is, therefore, an object of the present invention to provide a heat exchanger for a motor vehicle which overcomes the foregoing drawbacks and can prevent damage to tubes of a heat exchanger due to thermal stress caused by non-uniform hit of air flow.

### SUMMARY OF THE INVENTION

According to a first aspect of the present invention there is provided a heat exchanger for a motor vehicle including a pair of tanks apart from each other, and a core part including a plurality of tubes and a plurality of fins. Each of the fins is arranged between the adjacent tubes, and the tubes are fixed at both end portions thereof with the tanks so that circulating medium can be cooled by air flow running through the core part and flows through the tubes and tanks. Connecting portions of the tubes and the tanks are covered by a windbreak member so that the connecting portions are prevented from being hit by the air flow running through the core port.

Therefore, this heat exchanger can prevent the damage to its tubes due to thermal stress caused by non-uniform hit of air flow, ensuring a cooling performance.

Preferably, the windbreak member is formed of a part of a fan shroud.

Therefore, this can decrease its manufacturing cost, by lessening the numbers of parts and manufacturing process.

Preferably, the windbreak portion is formed of an air guide member arranged in front of the heat exchanger.

Therefore, this can decrease its manufacturing cost, by lessening the numbers of parts and manufacturing process.

Preferably, the windbreak portion extends in substantially parallel with the tubes.

Therefore, air flow toward the connecting portions of the tubes can be effectively suppressed.

Preferably, the windbreak portion is projected from one of the tanks toward the other of the tanks, and has a projecting length set to be 5 mm to 20 mm.

Therefore, this prevents the connecting portions of the tubes from the damage due to thermal differences caused by non-uniform hit of the air flow, ensuring the cooling performance.

Preferably, the windbreak portion is apart from the tubes.

Therefore, the windbreak portion can be formed easily and at low manufacturing cost.

Preferably, a pad member is filled between the windbreak portion and the tubes.

Therefore, the pad member ensures to prevent the air flow to hit the connecting portions of the tubes.

Preferably, the windbreak portion contacts at least partially with the tubes.

Therefore, the windbreak portion ensures to prevent the air flow to hit the connecting portions of the tubes.

### BRIEF DESCRIPTION OF THE DRAWINGS

The objects, features and advantages of the present invention will become apparent as the description proceeds when taken in conjunction with the accompanying drawings, in which:

FIG. 1 is an exploded perspective view showing a heat exchanger of the first embodiment according to the present invention, in a state before a fan shroud is fixed to the heat exchanger;

FIG. 2 is a perspective view showing the heat exchanger of the first embodiment, in a state after the heat changer and the fan shroud are assembled with each other;

FIG. 3 is an enlarged partial perspective view showing a radiator core part and a condenser core part which are used in the heat exchanger and attached at its upper portion with an upper reinforcement member;

FIG. 4 is a plan view showing the heat exchanger of the first embodiment;

FIG. 5 is an enlarged sectional plan view showing connecting portions of tubes and tanks of the radiator core part and the condenser core part of the heat exchanger;

FIG. 6 is a schematic diagram of a radiator and a condenser of the heat exchanger, showing how circulating medium flows in them;

FIG. 7 is a diagram showing a relationship between a projecting length of a windbreak portion of the fan shroud and strain value of a tube used in the core part, which is obtained by an experiment;

FIG. 8 is a front view of the core part of the radiator, showing positions where strain gauges are located in order to detect strain value shown in FIG. 7;

FIG. 9 is an exploded perspective view showing a heat exchanger, having a radiator, a condenser and two air guide members, of a second embodiment according to the present invention;

FIG. 10 is a perspective view showing the heat exchanger of the second embodiment, in which the radiator, the condenser and the air guide members are assembled with one another;

FIG. 11 is an enlarged sectional plan view showing a windbreak portion of a fan shroud, for covering connecting portions of a tube and a tank of a core part of a heat exchanger, of a modification of the windbreak portion the first embodiment shown in FIG. 5; and

FIG. 12 is an enlarged sectional plan view showing a windbreak portion of a fan shroud, for covering connecting portions of a tube and a tank of a core part of a heat exchanger, of another modification of the windbreak portion the first embodiment shown in FIG. 5

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

A heat exchanger of a first embodiment according to the present invention will be described with reference to the accompanying drawings. In the following description, terms “right” and “left” used herein do not correspond to those of the accompanying drawings, but to those with respect to the vehicle body. In addition, a front direction is indicated by “F” and a rear direction is indicated by “R” in the drawings.

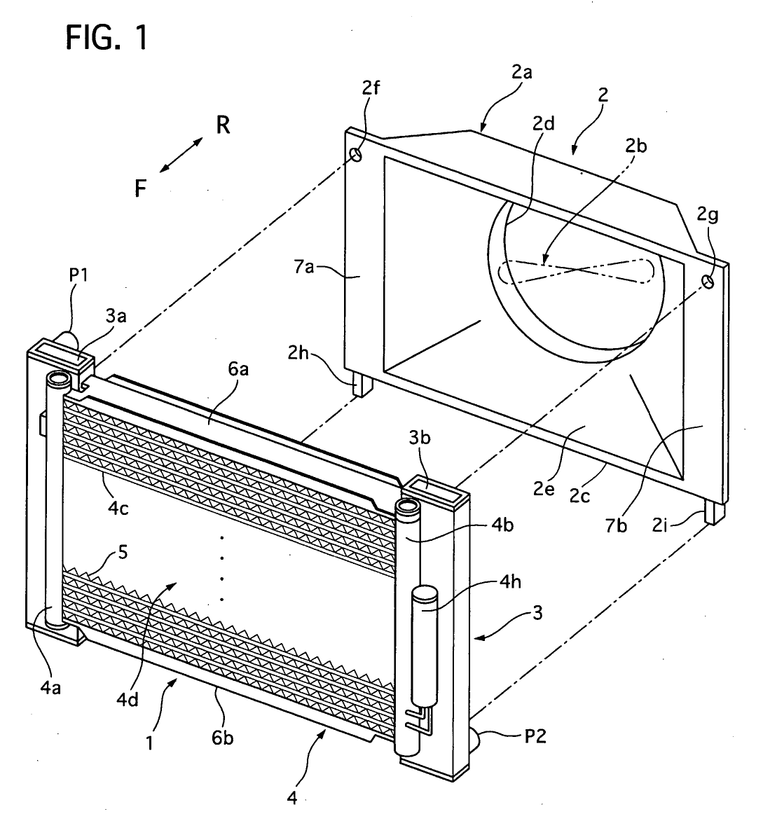

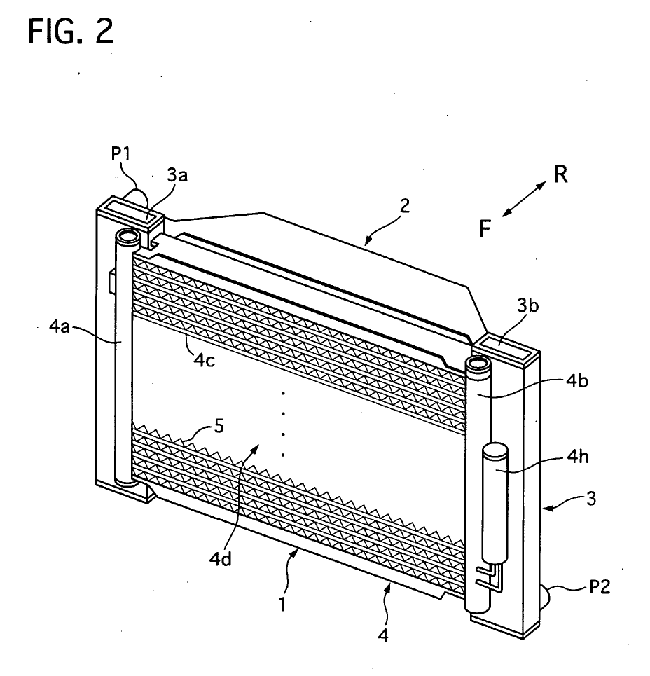

Referring to FIGS. 1 and 2, there is shown the heat exchanger 1 of the first embodiment in an exploded state and an assembled state, respectively. The heat exchanger 1 is mounted on a front end portion of a not-shown vehicle body of a motor vehicle.

The heat exchanger 1 of the first embodiment includes a radiator 3 for cooling a not-shown engine and a condenser 4 of an air-conditioner for cooling a not-shown passenger compartment. The condenser 4 is located at a front side of the radiator 3 and stacked therewith, and the fan shroud 2 is located at a rear side of the radiator 3 and fixed thereto. The heat exchanger 1 is attached at its rear side with a fan shroud 2 for guiding air flow.

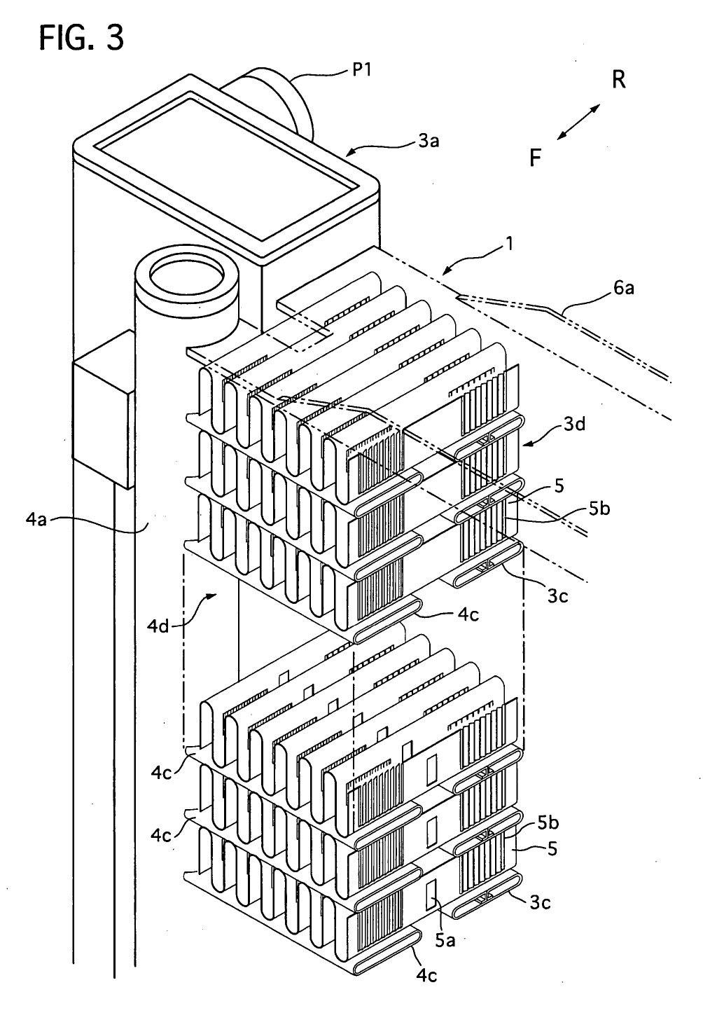

The radiator 3 has a pair of radiator tanks, consisting of a right side radiator tank 3a and a left side radiator tank 3b which are apart from each other in a lateral direction of the vehicle body, and a radiator core part 3d located between the right and left side radiator tanks 3a and 3b as shown in FIG. 3. The radiator core part 3d acts as a core part of the present invention, and a right and left side radiator tanks 3a and 3b act as a pair of tanks of the present invention.

The right side radiator tank 3a is provided with a first port P1 projecting rearward from an upper portion thereof, and the left side radiator tank 3b is provided with a second port P2 projecting rearward from a lower portion thereof. The first port P1 is fluidically connected with the engine and the second port P2 is fluidically connected with the engine through a not-shown water pump.

As shown in FIG. 3, the radiator core part 3d has a plurality of tubes 3c and corrugated fins 5. The corrugated fins 5 act as fins of the present invention.

In this embodiment, what is called, B type flat tubes are used as the tubes 3c, which is not limited to this type tube. The B type flat tube has an oblate cross-section, and its inner space is separated into two parts by a partition portion to each form a passage for flowing coolant. The tubes 3c are fixed at their both end portions to the right and left side tanks 3a and 3b so that the coolant can flow between the tubes 3c and the right and left side tanks 3a and 3b. The coolant corresponds to circulating medium of the present invention.

The corrugated fins 5 are arranged in the lateral direction so that each tube 3c is sandwiched between the adjacent corrugated fins 5, contacting thereon.

On the other hand, the condenser 4 includes a pair of condenser tanks, consisting of a right side condenser tank 4a and a left side condenser tank 4b which is apart from each other in the lateral direction, and a condenser core part 4d located between the right and left side condenser tanks 4a and 4b. The condenser core part 4d acts as a core part of the present invention, and the right and left side condenser tanks 4a and 4b act as a pair of tanks of the present invention.

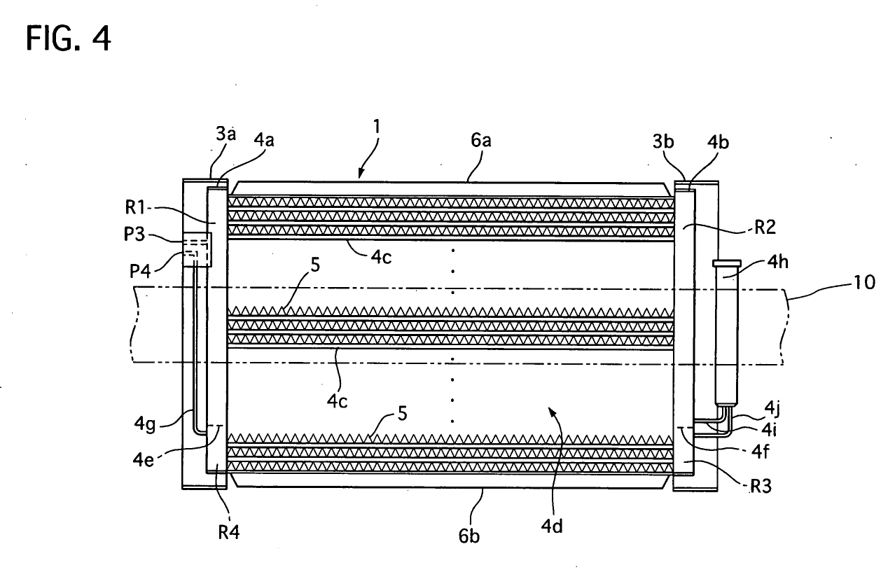

As shown in FIG. 4, the right side condenser tank 4a is formed inside thereof with a first room R1 and a fourth room R4, which are separated by a right partition plate 4e, and similarly the left side condenser tank 4b is formed inside thereof with a second room R2 and a third room R3, which are separated by a left partition plate 4f. The first room R1 is located over the fourth room R4, and has a space larger than that of the fourth room R4. The second room R2 is located over the third room R3, and has a space lager than the third room R3.

The right side condenser tank 4a is provided with a third port P3 and a fourth port P4 both projecting in the same lateral direction from its upper portion, where the third port P3 fluidically communicates with the first room R1 and the fourth port P4 fluidically communicates with the fourth room R4 via a pipe 4g. The third port P3 is fluidically connected with a not-shown compressor, and the fourth port P4 is fluidically connected with a not-shown expansion valve.

The left side condenser tank 4b is provided with a first pipe 4i and a second pipe 4j. The first pipe 4i is fluidically connected with the second room R2 at its one end portion and with a receiver 4h at its other end portion. The second pipe 4j is fluidically connected with the third room R3 at its one end portion and with the receiver at its other end portion.

The condenser core part 4d has a plurality of tubes 4c and corrugated fins 5 extending in the lateral direction. The tubes 4c are fixed at their both end portions to the right and left side condenser tanks 4a and 4b so that refrigerant can flow between the tubes 4c and the right and left side condenser tanks 4a and 4b. The corrugated fins 5 is arranged so that each tube 4c is sandwiched between the adjacent corrugated fins 5, contacting thereon.

Incidentally, the corrugated fins 5 in the first embodiment are used for the radiator 3 and the condenser 4, where their rear portions are used for the corrugated fins of the radiator core part 3d, and their front portions are used for the corrugated fins of the condenser core part 4d. They may be separated from each other for the radiator 3 and the condenser 4. In addition, as shown in FIG. 3, the corrugated fins 5 located at an upper side, corresponding to the first and second rooms R1 and R2, of the radiator and condenser core parts 3d and 4d are heat transmission fins, while the corrugated fins 5 located at its lower side corresponding to the third and forth rooms R3 and R4 are heat insulation fins having an opening 5a, but they are not limited to these type fins. Louvers 5b are formed near the tubes 3c and 4c, but they may be formed at other positions and have other shapes.

An upper reinforcement member 6a is attached to right and left upper portions of the right and left radiator tanks 4a and 4b and the right and left side condenser tanks 3a and 3b. Similarly, a lower reinforcement member 6b is attached to the lower portions of the right and left radiator tanks 4a and 4b and the right and left side condenser tanks 3a and 3b.

All parts described above of the heat exchanger 1 is made from aluminum, and its connecting parts are integrally fixed with each other by brazing, being heat-treated in a not-shown heating furnace after the heat exchanger 1 is tentatively assembled and one part of the connecting parts is provided with cladding layer, blazing sheet, made from brazing filler metal. Incidentally, the receiver 4h may be welded to the heat exchanger 1 by using a not-shown bracket.

As shown in FIG. 1, the fan shroud 2 includes a fan shroud body 2a for guiding air flow and a fan driven by a not-shown electric motor is installed so as to produce the air flow. The fan shroud body 2a is integrally made of resin, has a rectangular frame portion 2c and a shroud portion 2e integrally informed on a rear side of the rectangular frame portion 2c. The frame portion 2c has a right windbreak portion 7a and a left windbreak portion 7b, which will later be described in detail, at its front right side and left side, respectively, to be putted on right and left rear surfaces of the right and left radiator tanks 3a and 3b. The right and left windbreak portions 7a and 7b act as a windbreak member of the present invention.

The shroud portion 2e is formed to extend, inclining to narrow its cross-sectional area, from the frame portion 2c toward an opening 2d I which the fan 2b is installed. The fan 2b may employ a ring fan.

The frame portion 2c is provided with a right bolt hole 2f and a left bolt hole 2g at an upper right portion and an upper left portion thereof, respectively, and also provided with a right projection 2h and a left projection 2i at a lower right portion and a lower left portion of the frame portion 2c, respectively. Accordingly, the right and left projection 2h and 2i of the fan shroud body 2a are inserted in not-shown right and left pouched brackets provided on lower rear surfaces of the right and left radiator tanks 3a and 3b, respectively, and then not-shown two bolts are inserted through the bolt holes 2f and 2g of the fan shroud 2 and the right and left side radiator tanks 3a and 3b, screwing them on each other.

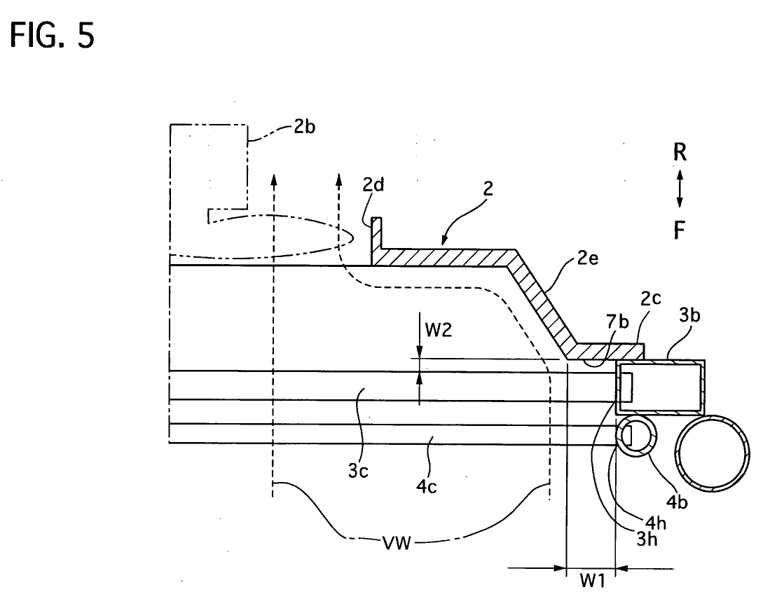

When the fan shroud 2 is attached to the heat exchanger 1 as described above, the right and left windbreak portions 7a and 7b are respectively projected in the lateral direction, in substantially parallel with the tubes 3c, by a projecting length W1 along tubes 3c and 4c toward the core portions 3d and 4d so as to cover connecting portions 3h of the tubes 3c and the right and left side radiator tanks 3a and 3b and connecting portions 4h of the tubes 4c and the right and left side condenser tanks 4a and 4b as shown in FIG. 5, which shows only left sides of the heat exchanger 1 and the fan shroud. Right sides thereof are not shown and symmetrical to the left sides.

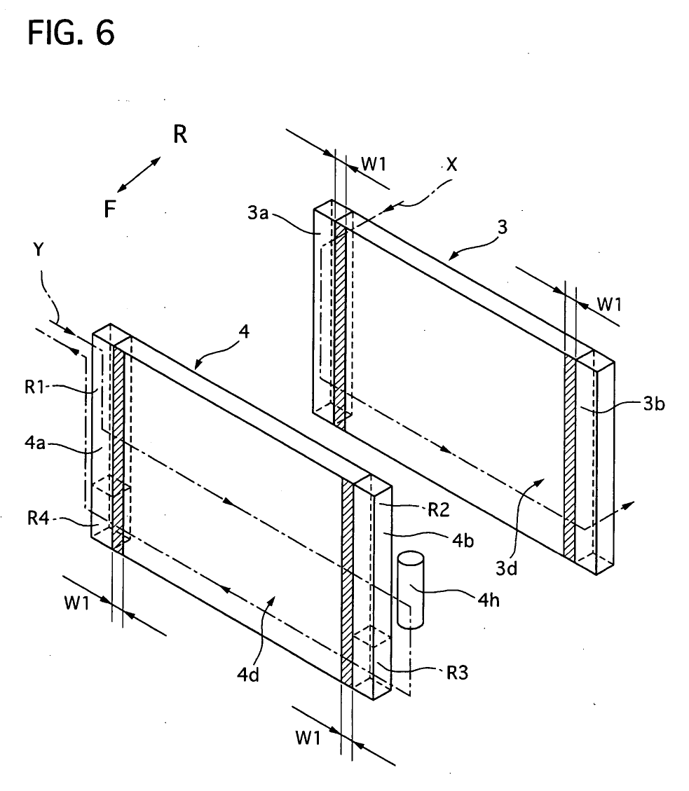

These covering areas by the windbreak portions 7a and 7b of the fan shroud 2 are indicated by slanted line parts in FIG. 6. The right and left windbreak portions 7a and 7b are apart rearward by a length W2 in a longitudinal direction of the vehicle body as shown in FIG. 5. The vertical length of an opening of the frame portion 2c is set to be the same as that of core parts 3d and 4d. A space formed between the windbreak portions 7a and 7b and tubes 3c may be filled up by a not-shown pad member. Note that the air flows as indicated by a dashed lines VW and substantially does not hit the connecting portions 3h and 4h, which are covered from their rear side by the windbreak portions 7a and 7b.

In the heat exchanger 1 of the first embodiment, as shown in FIG. 6, the coolant X at approximately 110° C. flows from an engine side into the right side radiator tank 3a through the first port P1 and is cooled down to approximately 60° C. because of heat transfer through the corrugated fins 5 between the coolant and the air flow caused when vehicle running and/or generated by the fan 2b while the coolant flows through the tubes 3c of the radiator core part 3d as indicated by an alternate long and short dash arrow. Then, the cooled coolant is discharged from the left side radiator tank 3b toward the engine side through the second port P2.

On the other hand, the refrigerant Y at approximately 70° C. flows from the compressor into the first room R1 of the right side condenser tank 4a through the third port P3 and then flows through tubes 4c, being cooled down because of heat transfer, into the second room R2 of the left side condenser tank 4b. Then, the refrigerant in the second room R2 is introduced through the pipe 4i to the receiver 4h, where the refrigerant is separated into gas and liquid, and then flows into the third room R3 of the left side condenser tank 4b through the pipe 4j. The refrigerant is supercooled down to approximately 45° C., because of heat transfer while it flows from the third room R3 into the fourth room R4 of the right side condenser tank 4a through tube 4c. This supercooled refrigerant is discharged from the fourth room R4 to the expansion valve, an evaporator side, through the pipe 4g and the fourth port P4.

In the above-described heat transfer, the air flow goes through the radiator core part 3d and the condenser core part 4d, where the connecting portions 3h and 4h are not hit by the air flow because the right and left windbreak portions 7a and 7b of the fan shroud 2. This suppresses temperature differences among the connecting portions 7a and 7b and decreases thermal stress thereon, thereby preventing the connecting portions 3h and 4h of the tubes 3c and 4c from damage. Note that although the tubes 3c and 4c can not avoid being non-uniformly hit by the air flow to cause temperature differences varying with location thereof, covering only the connecting portions 3h and 4h of the tubes 3c and 4c can prevent their damage.

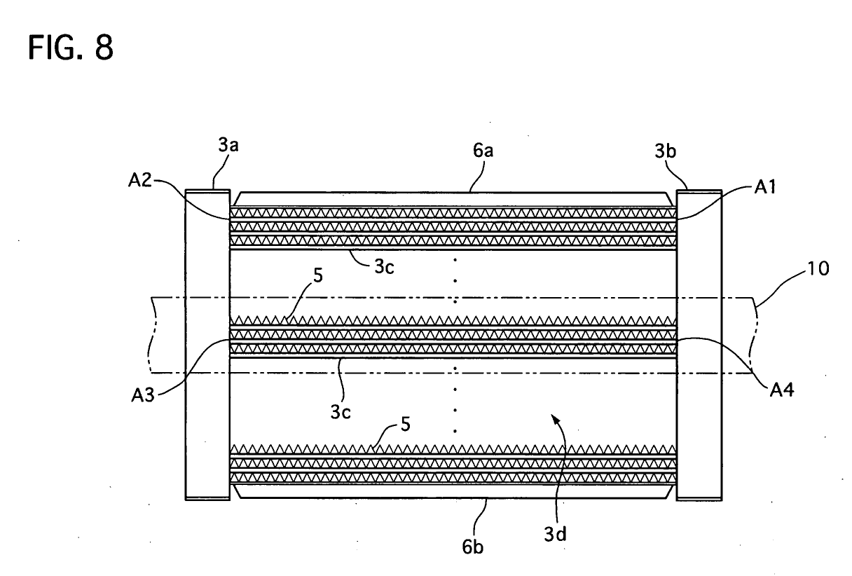

The projecting length W1 is set to be preferably from 5 mm to 20 mm according to the results of the following experiment. The relationship between the projecting length W1 and strain values is obtained by the experiment, in which the strain values are determined by varying the projecting length of the windbreak portions 7a and 7b from 0 mm to 20 mm. At the same time, the radiator 3, the condenser 4 and the fan 2b are operated in a simulated environment of vehicle running, where a bumper armature 10 is located in front of the condenser 3 as shown in FIG. 4. In addition, four strain gauges are attached to left and right end portions (the connecting portions 3h), at positions indicated by A1 to A4 in FIG. 8, of the uppermost tube 3c and the central tube 3c which is arranged behind the bumper armature 10.

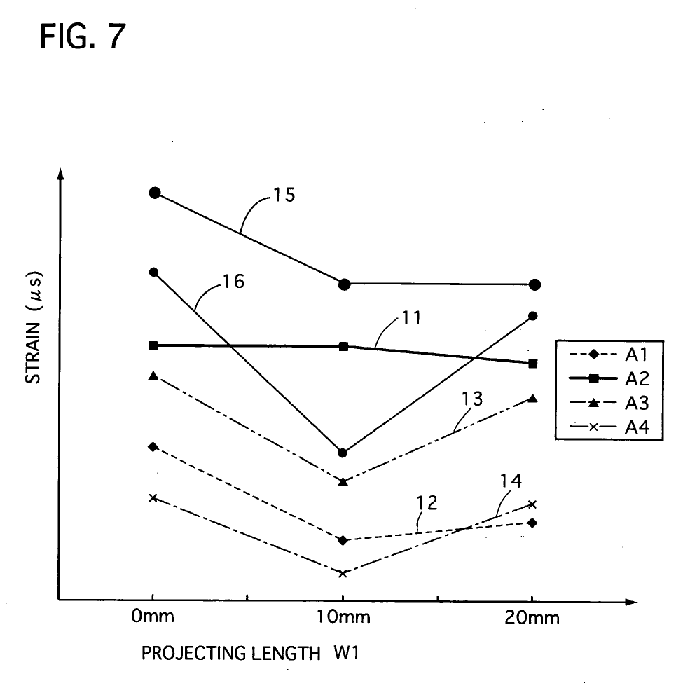

Its experimental results are shown in FIG. 7, in which a horizontal axis indicates a projecting length W1 of each of the windbreak portions 7a and 7b, a vertical axis indicates strain values. A conventional heat exchanger without a windbreak portion has strain values indicated at positions where the projecting length W1 is equal to zero, where the damage to the tube 3c may be occurred.

The strain values at the position A2, corresponding to the right connecting portion 3h of the uppermost tube 3c, are indicated by a solid line 11, varying a little regardless of the presence of the windbreak portion 7a, since the hot coolant before being cooled enters this position A2. The strain values at the position A1, corresponding to the left connecting portion 3h of the uppermost tube 3c, are indicated by a dashed line 12, becoming lower as the projecting length W1 of the windbreak portions becomes from 0 mm to 10 mm and then keeping almost the same values when the length W1 is within 10 mm to 20 mm, under the influence of the windbreak portion 7b. These values at the position A1 are lower than those at the position A2, because the coolant X is cooled while it flows through the uppermost tube 3c.

On the other hand, the strain values at the position A3, corresponding to the right connecting portion 3h of the central tube 3c, are indicated by a chain double-dashed line 13, becoming lower as the length W1 becomes from 0 mm to 10 mm and then higher as it becomes from 10 mm to 20 mm, under the influence of the windbreak portion 7a. These values at the position A3 are lower than those at the position A2 but higher than those at the position A1.

The strain values at the position A4, corresponding to the left connecting portion 3h of the central tube 3c, are indicated an alternate long and short line 14, becoming lower as the length W1 becomes from 0 mm to 10 mm and then higher as it becomes from 10 mm to 20 mm, under the influence of the windbreak portion 7b. These values at the position A4 are lower than those at the positions A1 to A3 when the length W1 is within 0 mm to approximately 17 mm, but higher than those at the position A1 when it is within approximately 17 mm to 20 mm.

Therefore, the uppermost tube 3c has the total strain vales at the positions A1 and A2, indicated by a solid line 15, and the central tube 3c has the total strain values at the positions A3 and A4, indicated by a solid line 16. The intermediate portions of the tubes 3c are not influenced by the windbreak portions 7a and 7b, and accordingly their strain values are not allowed for in FIG. 7. On the other hand, if the projecting length W1 is set more than 20 mm, a heat radiation area becomes smaller to cause adverse effect on cooling performance of the heat exchanger 1. Allowing for this results, the projecting length W1 is preferably set to be 5 mm to 20 mm.

The heat exchanger 1 of the first embodiment has the following advantages.

The windbreak portions 7a and 7b extend in the lateral direction to cover the connecting portions 3h and 4h of the tubes 3c and 4c and tanks 3a, 3b, 4a, and 4b, which prevents the windbreak portions 7a and 7b from being hit by the air flow running through the radiator core part 3d and the condenser core part 4d. This suppresses temperature differences of the connecting portions 3h and 4h to decrease strain thereof, thereby preventing the damage to the connecting portions 3h and 4h.

In addition, the windbreak portions 7a and 7b are formed by a part of the fan shroud 2, which can decrease the manufacturing costs because of lessening the numbers of parts and manufacturing processes.

Next, a heat exchanger for a motor vehicle of a second embodiment according to the present invention will be described with reference to the accompanying drawings.

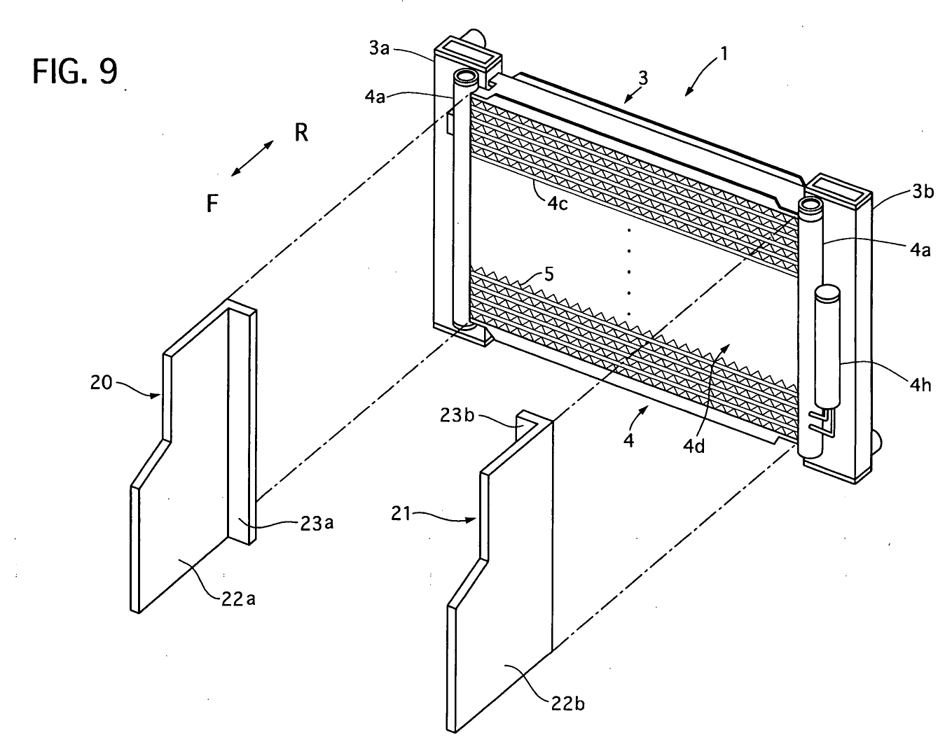

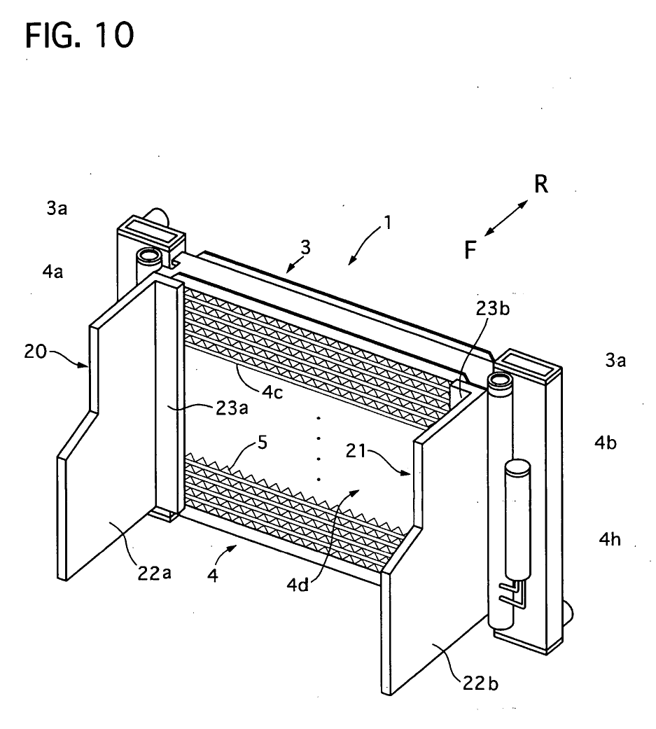

Referring to FIGS. 9 and 10, there is provided the heat exchanger 1 of the second embodiment, which consists of a radiator 3 and a condenser 4. The radiator 3 and the radiator 4 are constructed similarly to those of the first embodiment and provided with right air guide member 20 and left air guide member 21, which are arranged in front of the condenser 4.

The right and left air guide members 20 and 21 are made from foam material such as foamed polyurethane or foamed polypropylene, or from elastic resin such as rubber. They may be fixed to the heat exchanger 1 or to a not-shown radiator core support member by an adequate means according to their material.

The right air guide member 20 has an air guide portion 22a extending in a longitudinal direction of a motor vehicle and a windbreak portion 23a bending inward in a lateral direction of the vehicle body. Similarly, the left air guide member 21 has an air guide portion 22b extending in the longitudinal direction and a windbreak portion 23b bending inward in the lateral direction. The windbreak portions 23a and 23b act as a windbreak member of the present invention.

The windbreak portions 23a and 23b of the right and left air guide members 20 and 21 cover connecting portions of tubes 4c and right and left condenser tanks 4a and 4b and connecting portions of not-shown tubes and right and left radiator tanks 3a and 3b by a projecting length W1 in the lateral direction so that the connecting portions are not hit by air flow. The other parts of the heat exchanger of the second embodiment are similar to those of the first embodiment, since the windbreak portions 23a and 23b are formed by the air guide members 20 and 21.

This heat exchanger of the second embodiment has advantages similar to those of the first embodiment.

While there have been particularly shown and described with reference to preferred embodiments thereof, it will be understood that various modifications may be made therein, and it is intended to cover in the appended claims all such modifications as fall within the true spirit and scope of the invention.

For example, in the first and second embodiments, the heat exchanger 1 has the radiator 3 and the condenser 4, which are integrally assembled with each other, but a heat exchanger of the invention may be a radiator and a condenser which are separated from each other, only one of them, sub-radiator, or the like.

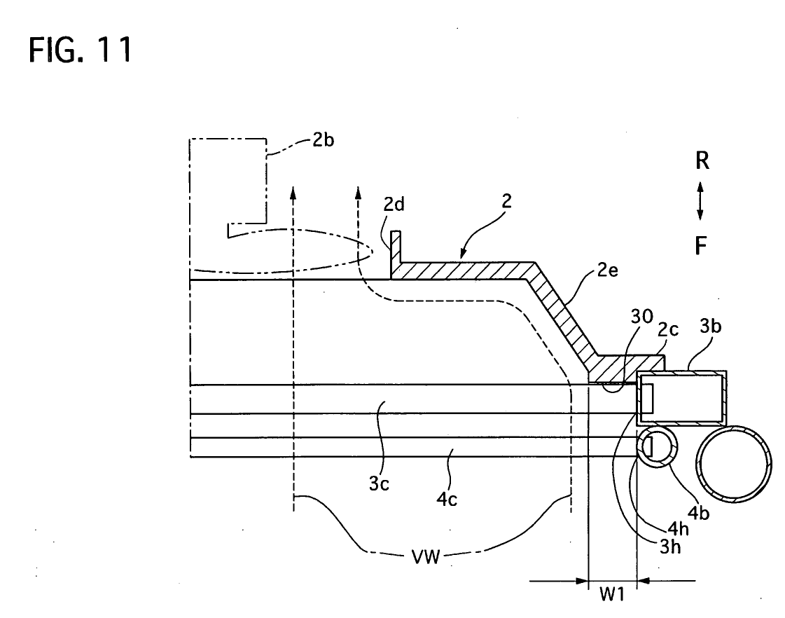

The windbreak portions 7a and 7b of the fan shroud 2 may be modified as shown in FIG. 11. A left windbreak portion 30 projects inward in the lateral direction by a projecting length W1 when the fan shroud 2 is fixed to the heat exchanger so as to cover the connecting portions 3h and 4h, and has a thickness contactable with the tube 3c. A not-shown right windbreak portion is also formed on the frame portion 2c in symmetrical to the left windbreak portion 30. The windbreak portions 30 act as a windbreak member of the present invention. These windbreak portions 30 can improve its windbreak performance for the connecting portions 3h and 4h.

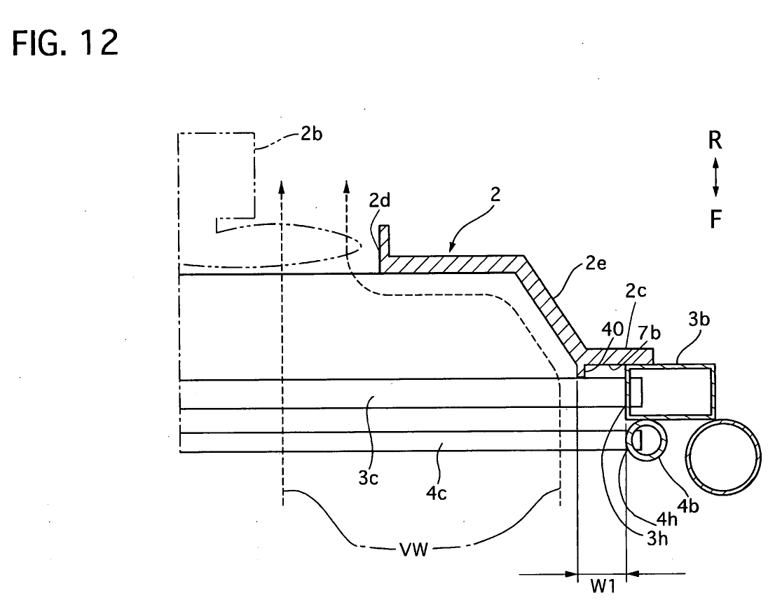

Instead of the windbreak portions 30 in FIG. 11, a left windbreak portion 7b may be modified to form a letter L shape as shown in FIG. 12, where the left windbreak portion 7b has a projecting portion 40 contactable with the tube 3c, forming a space defined by the projecting portion 40, the windbreak portion 7b, the tube 3c and the left side radiator tank 3b. A not-shown right windbreak portion is also formed on the frame portion 2c in symmetrical to the left windbreak portion 7b. The windbreak portions 7b with the projecting portion 40 act as a windbreak member of the present invention. These windbreak portions 7b can improve its windbreak performance for the connecting portions 3h and 4h.

The entire contents of Japanese Patent Application No. 2005-255385 filed Sep. 2, 2005 are incorporated herein by reference.

What is claimed is:

1. A heat exchanger for a motor vehicle comprising:
a pair of tanks apart from each other; and
a core part including a plurality of tubes and a plurality of fins, each of the fins being arranged between the adjacent tubes, and the tubes being fixed at both end portions thereof with the tanks so that circulating medium can be cooled by air flow running through the core part and flows through the tubes and tanks, wherein
connecting portions of the tubes and the tanks are covered by a windbreak member so that the connecting portions are prevented from being hit by the air flow running through the core port.

2. The heat exchanger according to claim 1, wherein
the windbreak member is formed of a part of a fan shroud.

3. The heat exchanger according to claim 2, wherein
the windbreak portion extends in substantially parallel with the tubes.

4. The heat exchanger according to claim 2, wherein
the windbreak portion is projected from one of the tanks toward the other of the tanks, and has a projecting length set to be 5 mm to 20 mm.

5. The heat exchanger according to claim 2, wherein
the windbreak portion is apart from the tubes.

6. The heat exchanger according to claim 5, wherein
a pad member is filled between the windbreak portion and the tubes.

7. The heat exchanger according to claim 2, wherein
the windbreak portion contacts at least partially with the tubes.

8. The heat exchanger according to claim 1, wherein
the windbreak portion is formed of an air guide member arranged in front of the heat exchanger.

9. The heat exchanger according to claim 8, wherein
the windbreak portion extends in substantially parallel with the tubes.

10. The heat exchanger according to claim 8, wherein
the windbreak portion is projected from one of the tanks toward the other of the tanks, and has a projecting length set to be 5 mm to 20 mm.

11. The heat exchanger according to claim 8, wherein
the windbreak portion is apart from the tubes.

12. The heat exchanger according to claim 11, wherein
a pad member is filled between the windbreak portion and the tubes.

13. The heat exchanger according to claim 8, wherein
the windbreak portion contacts at least partially with the tubes.

14. The heat exchanger according to claim 1, wherein
the windbreak portion extends in substantially parallel with the tubes.

15. The heat exchanger according to claim 1, wherein
the windbreak portion is projected from one of the tanks toward the other of the tanks, and has a projecting length set to be 5 mm to 20 mm.

16. The heat exchanger according to claim 1, wherein
the windbreak portion is apart from the tubes.

17. The heat exchanger according to claim 16, wherein
a pad member is filled between the windbreak portion and the tubes.

18. The heat exchanger according to claim 1, wherein
the windbreak portion contacts at least partially with the tubes.
